(19) United States
(12) Patent Application Publication
(10) Pub. No.: US 2022/0092186 A1
(43) Pub. Date: Mar. 24, 2022

(54) SECURITY INFORMATION ANALYSIS DEVICE, SYSTEM, METHOD AND PROGRAM

(71) Applicant: NEC Corporation, Minato-ku, Tokyo (JP)

(72) Inventor: Masaru KAWAKITA, Tokyo (JP)

(73) Assignee: NEC Corporation, Minato-ku, Tokyo (JP)

(21) Appl. No.: 17/424,395

(22) PCT Filed: Jan. 25, 2019
(86) PCT No.: PCT/JP2019/002448

§ 371 Date: Jul. 20, 2021

(51) Int. Cl. G06F 21/57; G06F 16/2457; G06N 20/00

(52) U.S. Cl. CPC G06F 21/57; G06F 2221/034; G06N 20/00; G06F 16/24578

(57) ABSTRACT

Control means 81 repeats processing of acquiring new security information by inputting security information indicating information regarding a security event to search means for receiving input information and searching for the security information from an information provider that provides the security information and searching for another new security information by inputting the acquired security information to the search means. Simplification information storage means 82 stores simplification information defining a method for simplifying a combination of search means in which security information to be obtained does not increase. The control means 81 changes the search for the security information to a search corresponding to the method indicated by the simplification information when a route of the search means used for a series of searches for the security information includes the combination defined by the simplification information.

### TECHNICAL FIELD

The present invention relates to a security information analysis device, a security information analysis system, a security information analysis method, and a security information analysis program for analyzing useful information on a certain security event.

### BACKGROUND ART

Security threats to information processing devices (computers and the like) and industrial machine devices (Internet of Things (IoT) devices and the like) have become social problems.

When a cyberattack that gives an unauthorized command to the information processing device occurs, a person in charge of security (person who collects and analyzes information regarding security, takes countermeasures, and the like) collects information regarding the cyberattack by using, for example, information such as a name of malware (unauthorized software, program, or the like) used for attacks, Internet Protocol (IP) addresses of a communication source and a communication destination, and an occurrence date and time. At this time, the person in charge of security searches for useful information for coping with the cyberattack by further searching for related information by using the collected fragmentary information.

For example, the following technology is disclosed in relation to coping with the cyberattack.

PTL 1 discloses a technology for determining a value of a response to an attack on an asset from an asset value assigned to the asset that is attacked via a network and a threat value assigned to the attack.

PTL 2 discloses a technology for generating evaluation information regarding a website to be evaluated in terms of security by using direct information collected by directly accessing the website to be evaluated and information regarding a security state of the website to be evaluated which is acquired from an information providing site.

PTL 3 discloses a security information analysis device capable of easily collecting useful information regarding security. The security information analysis device disclosed in PTL 3 learns an analysis model such that a weight of a security information collection unit that can acquire another security information included in training data from an information provider increases.

NPL 1 discloses an algorithm of Q-learning using a neural network.

### CITATION LIST

### Patent Literature

PTL 1: Japanese National Publication of International Patent Application No. 2012-503805
PTL 2: Japanese Patent No. 5580261
PTL 3: International Publication No. WO2018/139458

### Non Patent Literature

NPL 1: Volodymyr Mnih, Koray Kavukcuoglu, David Silver, Alex Graves, loannis Antonoglou, Daan Wierstra, Martin A. Riedmiller, “Playing Atari with Deep Reinforcement Learning”, [online], Dec. 19, 2013, CoRR (Computing Research Repositoly), [search on Jan. 21, 2019], Internet <URL:http://arxiv.org/abs/1312.5602>.

### SUMMARY OF INVENTION

### Technical Problem

Since the security threats such as cyberattacks have been increased, a time required for searching for, collecting, and analyzing information (hereinafter, simply referred to as “security information”.) related to the security threats has also been increased. Thus, the number of man-hours (work load) of the person in charge of security required for these works has also been increased.

When a huge amount of collected information is presented as it is to a person in charge of security countermeasures, useful threat information cannot be found, and thus, it may be difficult to utilize the information for countermeasures.

PTL 1 describes that an event that violates a security policy is detected and data associated with the event is stored. However, for example, when a new attack (attack) not set in the policy occurs, appropriate data may not be stored. When cyberattacks frequently occur, there is a possibility that a large amount of data is stored. When the technology disclosed in PTL 2 is used, it is necessary for the person in charge of security to select an appropriate website and analyze the collected information.

Both the technologies disclosed in PTL 1 and PTL 2 may not collect useful information for the person in charge of security. It may be difficult to collect appropriate information depending on knowledge and experience of the person in charge of security.

On the other hand, in the technology described in PTL 3, the presence of search means that presents another threat information from a part of the threat information is considered. Since there are many search means, search means to be applied to the threat information and an extraction order of only useful threat information depend on the experience of the person in charge of security responsible for analysis.

In consideration of such a situation, an automatic analysis method performed such that the person in charge of security who extracts useful threat information learns a combination of threat information and search means applied to the threat information by machine learning and useful threat information for new threat information is extracted based on the learning result is considered.

In general, the machine learning is performed for a large amount of data over a long time. On the other hand, since there are many search means and usefulness changes quickly, rapid learning is required.

It is possible to extract useful threat information by machine learning by using the technology described in PTL 3. However, when the technology described in PTL 3 is used and the number of types of search means increases, a time required for learning also increases, and rapid learning becomes difficult.

Accordingly, an object of the present invention is to provide a security information analysis device, a security information analysis system, a security information analysis method, and a security information analysis program capable of efficiently collecting useful information regarding security.

### Solution to Problem

A security information analysis device according to the present invention includes control means for repeating processing of acquiring new security information by inputting security information indicating information regarding a security event to search means for receiving input information and searching for the security information from an information provider that provides the security information and searching for another new security information by inputting the acquired security information to the search means, and simplification information storage means for storing simplification information defining a method for simplifying a combination of search means in which security information to be obtained does not increase. The control means changes the search for the security information to a search corresponding to the method indicated by the simplification information when a route of the search means used for a series of searches for the security information includes the combination defined by the simplification information.

A security information analysis system according to the present invention includes the security information analysis device, evaluation means for repeating processing of selecting search means in accordance with a weight calculated by applying security information to an analysis model and processing of acquiring other security information by using the selected search means, and evaluation result providing means for generating a route based on the acquired security information.

A security information analysis method according to the present invention includes repeating processing of acquiring new security information by inputting security information indicating information regarding a security event to search means for receiving input information and searching for the security information from an information provider that provides the security information and searching for another new security information by inputting the acquired security information to the search means. The search for the security information is changed to a search corresponding to a method indicated by simplification information defining a method for simplifying a combination of search means in which security information to be obtained does not increase when a route of the search means used for a series of searches for the security information includes the combination defined by the simplification information.

A security information analysis program according to the present invention causes a computer to execute control processing of repeating processing of acquiring new security information by inputting security information indicating information regarding a security event to search means for receiving input information and searching for the security information from an information provider that provides the security information and searching for another new security information by inputting the acquired security information to the search means. In the control processing, the search for the security information is changed to a search corresponding to a method indicated by simplification information defining a method for simplifying a combination of search means in which security information to be obtained does not increase when a route of the search means used for a series of searches for the security information includes the combination defined by the simplification information.

### Advantageous Effects of Invention

According to the present invention, it is possible to efficiently collect useful information regarding security.

### BRIEF DESCRIPTION OF DRAWINGS

FIG. 1 It depicts a block diagram illustrating a functional configuration example of a security information analysis device.

FIG. 2 It depicts a block diagram illustrating a functional configuration example of a security information evaluation device.

FIG. 3 It depicts a block diagram illustrating a functional configuration example of a security information analysis system.

FIG. 4 It depicts a block diagram illustrating another functional configuration example of the security information analysis system.

FIG. 5 It depicts an explanatory diagram illustrating a definition example of search means.

FIG. 6 It depicts an explanatory diagram illustrating another definition example of the search means.

FIG. 7 It depicts an explanatory diagram illustrating an example of a table defining simplification information.

FIG. 8 It depicts an explanatory diagram conceptually illustrating an example of a learning graph.

FIG. 9 It depicts an explanatory diagram illustrating an example of a learning procedure of an analysis model.

FIG. 10 It depicts an explanatory diagram illustrating an example of a relationship between a learning graph and training data.

FIG. 11 It depicts an explanatory diagram illustrating an example of processing of suppressing information collection processing by the search means.

FIG. 12 It depicts a block diagram illustrating an example of a specific configuration of a learning unit and a simplification information storage unit.

FIG. 13 It depicts a flowchart illustrating an operation example of the security information analysis device.

FIG. 14 It depicts a flowchart illustrating an operation example of an evaluation unit.

FIG. 15 It depicts an explanatory diagram illustrating an example of a generated evaluation graph.

FIG. 16 It depicts an explanatory diagram illustrating an example of specific processing of evaluation.

FIG. 17 It depicts an explanatory diagram illustrating a configuration example using a general-purpose hardware device.

FIG. 18 It depicts a block diagram illustrating an outline of the security information analysis device according to the present invention.

FIG. 19 It depicts a block diagram illustrating an outline of the security information analysis system according to the present invention.

### DESCRIPTION OF EMBODIMENTS

Technical considerations and the like in the present disclosure will be described in detail. Hereinafter, various events (incidents) that may cause a security problem including a cyberattack, unauthorized access, and the like may be referred to as “security events” (“security incidents”). In the present disclosure, the security information is not particularly limited, and can include a wide range of information regarding a certain security event. A specific example of the security information will be described later.

Hereinafter, a typical response of a person in charge of security when the security event such as the cyberattack occurs will be exemplified.

When the security event such as the cyberattack occurs, the person in charge of security selects a keyword (search word) from information (for example, a name of malware, a malware main body, information regarding communication executed by malware, and the like) obtained early in relation to the security event.

The person in charge of security acquires information regarding the keyword from a provider (hereinafter, referred to as an information source.) who provides information regarding security by using the selected keyword. Such an information source may typically be, for example, an information site that collects and provides vulnerability information, cyberattack information, and the like via a communication network, an online database, or the like. For example, the person in charge of security searches for information regarding a certain keyword from the information source, and acquires the search result as new information.

The person in charge of security selects an additional keyword from the acquired fragmentary information, and further acquires information by using the keyword. The person in charge of security repeats the above processing until sufficient information regarding security countermeasures against the cyberattack is obtained. The person in charge of security extracts (selects) useful information from the collected information based on knowledge and experience, and performs security countermeasures to prevent an additional attack.

With an increase in the number of cyberattacks, the number of man-hours of the person in charge of security required to collect and analyze the security information increases, and the amount of information to be collected also increases. When information collection and analysis operations are manually executed, knowledge, experience, and the like of the person in charge of security who executes these operations influence the accuracy of the evaluation result and an operation load.

Thus, a consideration that provides a technology capable of collecting information useful for security countermeasures without depending on knowledge, experience, or the like of the person in charge of security is one of the technical considerations in the present disclosure.

An exemplary embodiment of the technology according to the present disclosure can create an analysis model used for collecting useful security information regarding a certain security event. Due to the use of the analysis model, for example, when security information regarding a certain security event is given, it is possible to appropriately select processing (hereinafter, referred to as information collection processing) of acquiring other useful security information from the information source.

The security information collected by the person in charge of security may include data (for example, an internet protocol (IP) address, a host name, a hash value of malware binary, and the like) with certain static features (for example, patterns). Accordingly, in the exemplary embodiment of the technology according to the present disclosure, the analysis model is configured to learn static features of data included in the security information.

The person in charge of security may appropriately change the information to be collected in accordance with the stage of information collection. As a specific example, it is assumed that another security information is collected based on the same type of security information (for example, IP address). In an early stage shortly after the security event has occurred, the person in charge of security may typically collect, for example, information capable of being easily collected for certain security information (for example, a host name for an IP address or the like). On the other hand, at the stage at which the analysis related to the security event is executed to some extent, the person in charge of security may collect, for example, information that is not easily acquired or information that requires cost for acquisition for the same type of security information.

Accordingly, in the exemplary embodiment of the technology according to the present disclosure, the analysis model is configured to learn an acquisition procedure (for example, the selection of an information provider, an information collection order, and the like) of security information regarding a certain security event.

The number of man-hours required to collect the information can be reduced by using the technology according to the present disclosure to be described by using the following exemplary embodiments. The reason is that information collection processing for acquiring other useful security information regarding the security event can be appropriately selected by using the analysis model when security information regarding a certain security event is given.

Accordingly, the useful information can be provided from the viewpoint of the person in charge of security for countermeasures against a certain security event. The reason is that the analysis model is learned by using training data of which usefulness is determined in advance by the person in charge of security or the like.

An object of the present exemplary embodiment is to further reduce the number of man-hours required to collect the information. Here, search means for presenting another threat information from a part of threat information is an independent service or protocol, but there are individual properties in types and values of data to be input and output.

Thus, for example, when certain search means searches for threat information for any threat information and then another search means further searches for threat information, new threat information may not be obtained. It is clear that this search does not contribute to obtaining useful threat information. In consideration of the property between the search means, whether or not such a situation occurs can be determined before the search by the search means.

When a plurality of search means searches for threat information for any threat information, the threat information obtained as a final output may not change regardless of a combination of search orders. Even though this search is performed on one or more combinations, a learning effect is not effectively obtained. Such a situation can also be determined before the search by the search means.

Based on such an assumption, in the present exemplary embodiment, a time required for learning is reduced by suitably scheduling the search order by the search means from the property of the search means defined in advance.

Hereinafter, the technology according to the present disclosure will be described in detail by using each exemplary embodiment. The configurations of the following exemplary embodiments (and modification examples thereof) are examples, and the technical scope of the technology according to the present disclosure is not limited thereto. That is, the division of the constituent components constituting each of the following exemplary embodiments (for example, division by a functional unit) is an example in which each exemplary embodiment can be realized. The configuration for realizing each exemplary embodiment is not limited to the following examples, and various configurations are assumed.

The constituent components constituting each of the following exemplary embodiments may be further divided. One or more constituent components constituting the following exemplary embodiments may be integrated. When each exemplary embodiment is realized by using one or more physical devices, virtual devices, and combinations thereof, one or more constituent components may be realized by one or more devices, and one constituent component may be realized by using a plurality of devices.

Hereinafter, exemplary embodiments capable of realizing the technology according to the present disclosure will be described. Constituent components of a system to be described below may be constituted by using a single device (physical or virtual device) or may be realized by using a plurality of separated devices (physical or virtual devices). When the constituent components of the system include the plurality of devices, the devices may be connected to be able to communicate by a wired or wireless communication network or a communication network in which the wired and wireless communication networks are appropriately combined. A hardware configuration capable of realizing the system and the constituent components thereof to be described below will be described later.

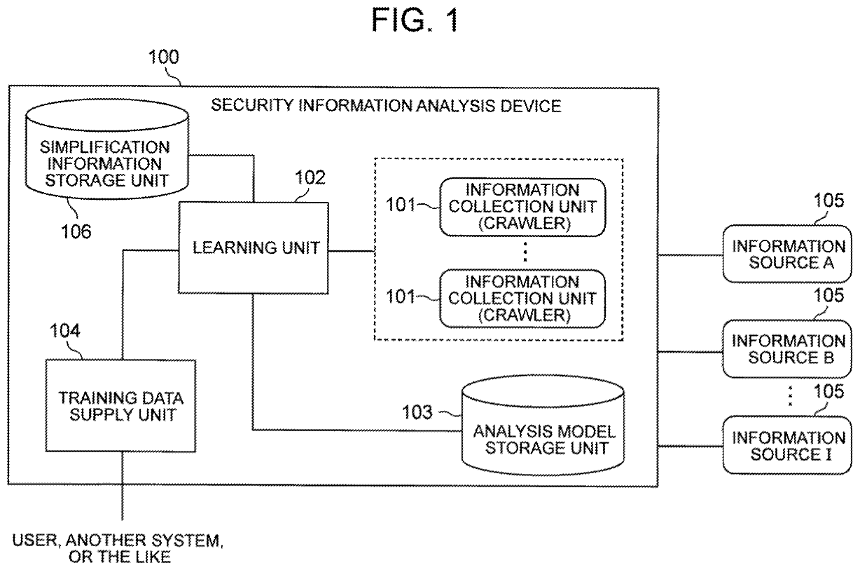

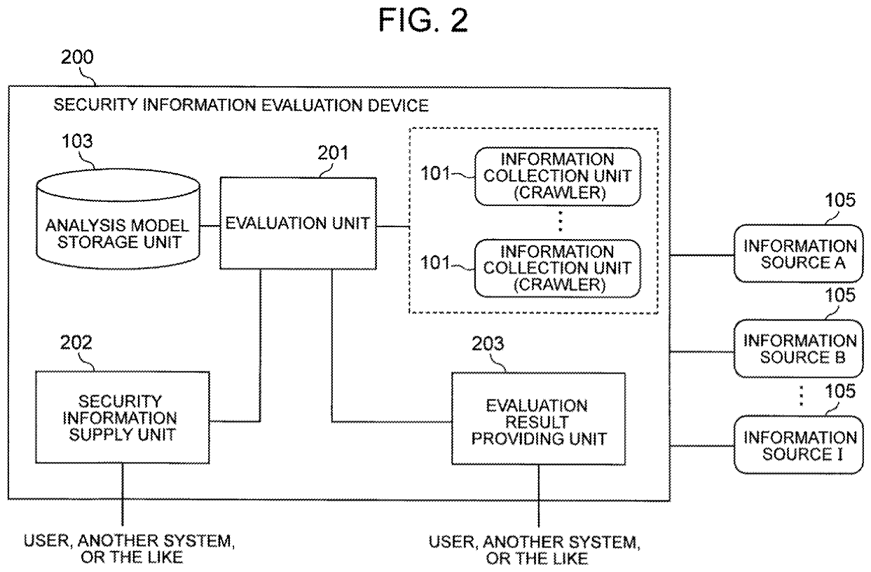

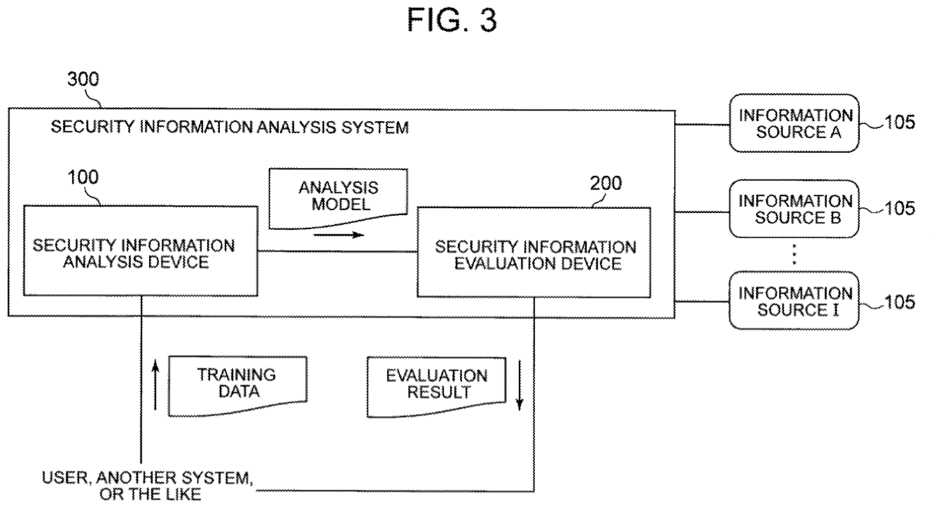

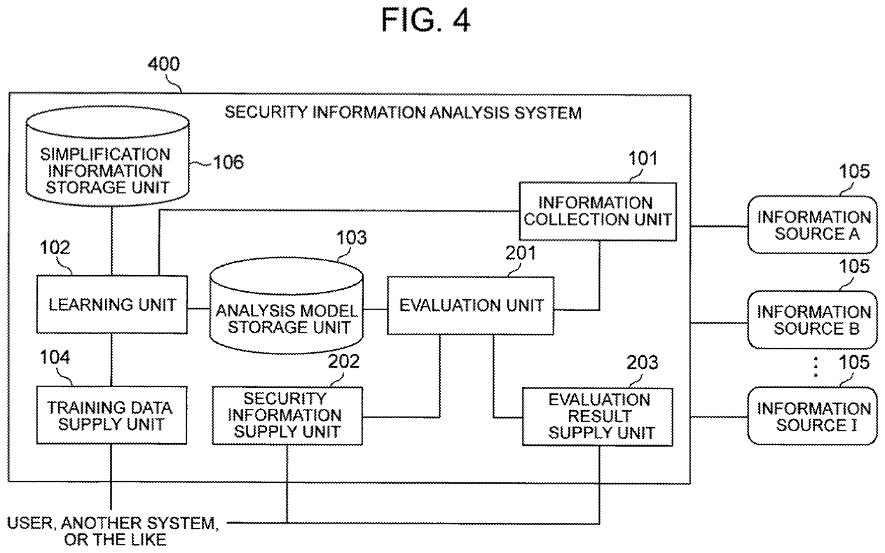

FIG. 1 is a block diagram illustrating a functional configuration of a security information analysis device 100 according to the present exemplary embodiment. FIG. 2 is a block diagram illustrating a functional configuration of a security information evaluation device 200 according to the present exemplary embodiment. FIG. 3 is a block diagram illustrating a functional configuration of a security information analysis system 300 according to the present exemplary embodiment. FIG. 4 is a block diagram illustrating another functional configuration of a security information analysis system 400 according to the present exemplary embodiment.

In FIGS. 1 to 4, constituent components capable of realizing similar functions are denoted by the same reference signs. Hereinafter, the constituent components will be described.

As illustrated in FIG. 1, the security information analysis device 100 according to the present exemplary embodiment includes information collection units 101, a learning unit 102, an analysis model storage unit 103, a training data supply unit 104, and a simplification information storage unit 106. These constituent components constituting the security information analysis device 100 may be connected to be able to communicate by using an appropriate communication method. The security information analysis device 100 is connected to be able to communicate with one or more information sources 105 which are information providers that provide various kinds of security information by using an appropriate communication method.

The information source 105 is the provider of the security information capable of providing another security information related to certain security information. The information source 105 is not particularly limited, and may widely include a service, a site, a database, and the like capable of providing information regarding security.

As a specific example, the information source 105 may be an external site that retains information regarding security (vulnerability, cyberattack, and the like) in a database or the like. For example, another security information (for example, information of malware that executes communication related to an IP, and the like) is obtained by searching for certain security information (for example, an IP address, a host name, or the like) at such an external site.

The information source 105 is not limited to the above example, and may be, for example, a Whois service or a Domain Name System (DNS) service. The information source 105 is not limited to the external site or service, and may be a database in which security information is locally accumulated.

The information collection unit 101 receives the input information and acquires (searches for) another security information related to the certain security information from the information source 105. For example, the information collection unit 101 may be individually provided for one or more information sources 105, or may have a function of collectively searching the information sources 105. Hereinafter, the information collection unit may be referred to as a crawler 101. For example, the crawler 101 may search for security information provided from the learning unit 102 (to be described later) from a certain information source 105, and provide, as another security information, the search result to the learning unit 102. As described above, since the crawler 101 searches for various kinds of security information, the information collection unit 101 or the crawler 101 can be referred to as search means.

The crawler 101 is configured to execute the information collection processing by using an appropriate method for each information source 105. As one specific example, the crawler 101 may transmit a search request (for example, a query or the like) to the information source 105 and may receive a response to the request. As another specific example, the crawler 101 may acquire contents (text data or the like) provided by the information source 105, and may search for appropriate security information from the acquired content. In the present exemplary embodiment, a special crawler 101 (hereinafter, referred to as an end processing crawler) indicating the end (termination) of the information collection processing may be prepared.

The learning unit 102 generates an analysis model that can be used to analyze the security information. Specifically, the learning unit 102 generates the analysis model by executing learning processing by using training data provided from the training data supply unit 104 (to be described later).

The analysis model is a model that can receive, as an input, security information on a certain security event, and can calculate a “weight” for each of the crawlers 101. The weight (weight of each crawler 101) calculated by the analysis model is information indicating usefulness (appropriateness) of information acquisition processing by a certain crawler 101. In the present exemplary embodiment, the usefulness of the information acquisition processing by each crawler 101 indicates, for example, the usefulness of the security information that can be acquired by each crawler 101.

The usefulness of the security information indicates, for example, usefulness as information used for analysis and countermeasures regarding a certain security event. The usefulness of the security information may be determined by the person in charge of security, another system, or the like. In the present exemplary embodiment, training data including security information of which usefulness is determined in advance is used for learning of the analysis model (to be described later).

The analysis model calculates a weight reflecting the usefulness of the security information that can be acquired by each crawler 101. More specifically, the analysis model is configured to calculate a relatively larger weight for the crawler 101 capable of acquiring another security information with high usefulness than for the other crawlers 101, for example, by using the security information given as the input.

That is, the crawler 101 having a large weight calculated when certain security information is input to the analysis model is selected, and thus, it is expected that other useful security information can be acquired. From such a viewpoint, the weight output by the analysis model can also be considered as information (selection information) capable of selecting an appropriate crawler 101 for certain security information.

The analysis model is not limited to the weights for the individual crawlers 101, but may be configured to provide weights for combinations (referred to as crawler sets) by the plurality of crawlers 101. That is, the analysis model can handle the crawler set as, for example, one virtual crawler. In this case, the results of the information collection processing by the crawler set are obtained by executing the information collection processing for certain security information by the crawlers 101 included in the crawler set and integrating the results.

The results of the information collection processing by the crawler set are a set including the security information acquired by the crawlers 101 included in the crawler set. Such a set is not particularly limited, and may be a union, a product set, or an exclusive OR set. Hereinafter, for the sake of convenience in description, the crawler 101 and the crawler set may be collectively referred to simply as the crawler 101.

The analysis model has any configuration. The analysis model may be, for example, a neural network. In this case, information indicating the security information is input to an input layer of the analysis model, and the weight for each crawler 101 is output from an output layer. In this case, the learning unit 102 may learn, for example, a neural network obtained by combining a first model and a second model as described in PTL 3. A specific learning method by the learning unit 102 will be described later.

The analysis model storage unit 103 stores the analysis model generated by the learning unit 102. A method for storing the analysis model by the analysis model storage unit 103 is not particularly limited, and an appropriate method can be adopted. For example, the analysis model storage unit 103 may dispose the analysis model in a memory region, or may record the analysis model in a file, a database, or the like. The security information analysis device 100 may provide the analysis model stored in the analysis model storage unit 103 to the outside (a user, another system, a device, or the like).

The training data supply unit 104 supplies the training data provided from the user or another system to the learning unit 102. The training data is a set of security information (that is, security information determined to be useful for a certain security event) useful for countermeasures regarding a certain security event.

A method for creating or acquiring the training data is not particularly limited, and an appropriate method can be adopted. As a specific example, the training data may be created by using the security information (analyzed security information) regarding the security event collected and accumulated in the past by the person in charge of security. As another specific example, the training data may be created by using data provided from another reliable system, a report created by a reliable external computer security incident response team (CSIRT), or the like.

For example, the training data can be created from vulnerability information, cyberattack information, or the like provided by a security-related company or organization, or the like. It is considered that knowledge of a person in charge of security, an external organization, or the like is reflected in the training data created as described above. A specific format and content of the training data will be described later.

The simplification information storage unit 106 stores information defining a method for simplifying a combination of search means (crawlers 101) in which obtained security information does not increase (hereinafter, referred to as simplification information.). The simplification information can be said to be information defining the nature of the search means.

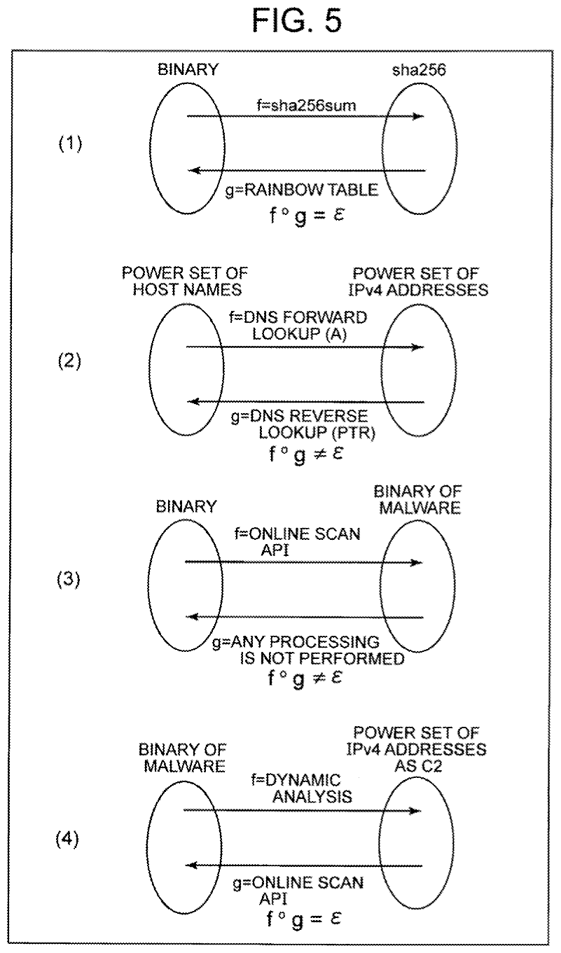

FIG. 5 is an explanatory diagram illustrating a definition example of the search means. FIG. 5 illustrates a relationship between two search means. When a sphere C in which the security information is used as a target and the search means is morphism is assumed, since it can be said that the search is to apply a map f: A→(A, B) to a∈A and b∈B, in FIG. 5, the maps indicating the information collection processing by the search means is indicated by f and g.

FIG. 5 illustrates four types of definition examples. A first definition example illustrates a relationship between information collection processing f of obtaining Secure Hash Algorithm (sha) 256 hash from binary and information collection processing g of obtaining binary from sha 256 hash (see FIG. 5(1)). For example, f is processing based on a sha 256 sum command, and g is processing based on a rainbow table.

In this case, the sha 256 is obtained by executing f on the binary, and the binary is obtained by executing g on the sha 256. That is, it can be said that even though g is executed based on the information obtained by executing f, new information is not obtained. Here, when a unit element is represented by c and a relationship between tasks of continuous information collection processing is represented by an operator ◯, f◯g=ε is established. Since this information is a combination of the tasks of information collection processing in which the obtained security information does not increase, the simplification information of f◯g=ε is defined.

A second definition example illustrates a relationship between information collection processing f of obtaining a power set of IPv4 address from a power set of host names and information collection processing g of obtaining a power set of host names from a power set of IPv4 addresses (see FIG. 5(2)). For example, f is processing based on a DNS forward lookup (A), and g is processing based on a DNS reverse lookup (PTR).

In this case, the power set of IPv4 addresses is obtained by executing f on the power set of host names, and the power set of host names is obtained by executing g on the power set of IPv4 addresses. That is, it can be said that even though g is executed based on the information obtained by executing f, new information is not obtained.

A third definition example illustrates a relationship between information collection processing f of obtaining binary of malware from binary and information collection processing g of obtaining binary from binary of malware (see FIG. 5(3)). For example, it is assumed that f is processing using an API of an online scan service, and g is processing that does not perform any processing.

In this case, the binary of the malware is obtained by executing f on the binary. Even though g is executed on the binary of the malware (except that additional information or the like is added), only the binary is obtained. That is, it can be said that even though g is executed based on the information obtained by executing f, new information is not obtained.

A fourth definition example illustrates a relationship between information collection processing f of obtaining a power set of IPv4 addresses that is C2 (Command and Control Server) from binary of malware and information collection processing g of obtaining a binary of malware from the power set of IPv4 addresses (see FIG. 5(4)). For example, f is processing based on dynamic analysis, and g is processing using an API of an online scan service.

In this case, f is executed on the binary of the malware, and thus, the power set of IPv4 addresses is obtained. g is executed on the power set of IPv4 addresses, and thus, the binary of the malware is obtained. That is, it can be said that even though g is executed based on the information obtained by executing f, new information is not obtained.

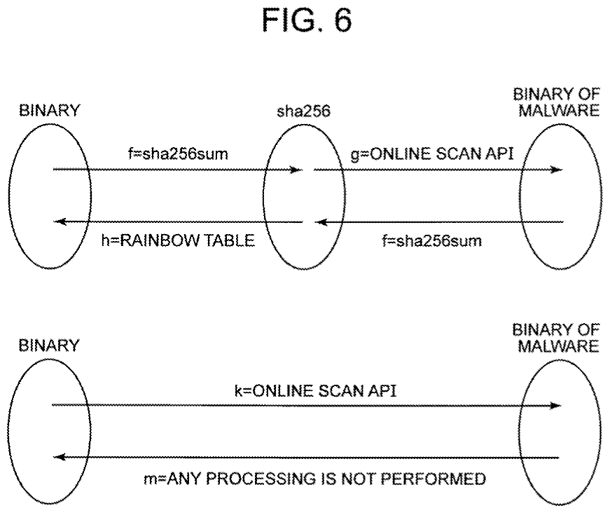

Although FIG. 5 illustrates a relationship between the two search means, a relationship between three or more search means may be used. FIG. 6 is an explanatory diagram illustrating another definition example of the search means.

The definition example illustrated in FIG. 6 illustrates a relationship between information collection processing f of obtaining SHA 256 hash from binary, information collection processing g of obtaining binary of malware from SHA 256 hash, information collection processing f of obtaining SHA 256 hash from binary of malware, and information collection processing h of obtaining binary from SHA 256 hash. For example, f is processing based on a sha 256 sum command, g is processing using an API of an online scan service, and h is processing based on a rainbow table. Information collection processing m indicates that processing is not performed.

For example, it is assumed that information collection processing k of obtaining binary of malware from binary is performed by an online scan service, f◯g=k is established. In order to obtain binary for binary of malware, information collection processing is not required. That is, h◯f=m is retained. In this case, since this information is the combination that can simplify the information collection processing in which the obtained security information does not increase, the simplification information of f◯g=k and h◯f=m is defined.

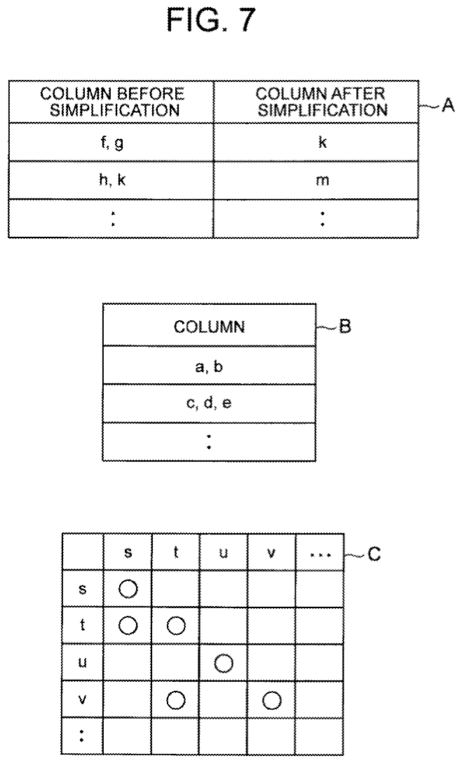

In the present exemplary embodiment, three types of simplification information are defined, and are defined as tables in the simplification information storage unit 106. FIG. 7 is an explanatory diagram illustrating an example of a table defining simplification information.

A first table (hereinafter, referred to as Table A.) is a table that retains a combination (that is, a combination of search means) of mappings that can be simplified so as to reduce the search means that performs the information collection processing. Table A illustrated in FIG. 7 illustrates an example in which combinations of search means before simplification and combinations of search means after simplification are retained in association with each other. For example, a first row in Table A indicates that a combination of the information collection processing f and the information collection processing g can be simplified to the information collection processing k.

A second table (hereinafter, referred to as Table B.) is a table that retains a combination (that is, a combination of search means) of maps in which synthesis becomes the unit element ∈ The combination of maps in which the synthesis becomes the unit element c can also be said to be a combination of maps that can be simplified so as to delete the information collection processing by the search means. Table B illustrated in X3 illustrates an example in which the combinations of search means capable of deleting the information collection processing are retained. For example, a first row in Table B indicates that processing of a combination of information collection processing a and information collection processing b can be deleted.

A third table (hereinafter, referred to as Table C.) is a table that retains a combination (that is, a combination of search means) of interchangeable maps. The combinations of the interchangeable maps are combinations in which the content of the security information finally obtained does not change even though the order of the pieces of information collection processing is changed. Table B illustrated in X3 illustrates an example in which the combinations of the interchangeable search means are retained. For example, a circle mark shown in a second row and a first column indicates that information collection processing s and information collection processing t are interchangeable. Although FIG. 3 illustrates a case where Table C is a two-dimensional table, the number of dimensions of Table C is not limited to two, and may be three or more.

A method for storing the simplification information by the simplification information storage unit 106 is not particularly limited, and an appropriate method can be adopted. For example, the simplification information storage unit 106 may dispose the simplification information in a memory region, or may record the analysis model in a file, a database, or the like.

Next, a configuration of the security information evaluation device 200 will be described with reference to FIG. 2. The security information evaluation device 200 according to the present exemplary embodiment includes information collection units 101, an evaluation unit 201, an analysis model storage unit 103, a security information supply unit 202, and an evaluation result providing unit 203. These constituent components constituting the security information evaluation device 200 may be connected to be able to communicate by using an appropriate communication method. The security information evaluation device 200 is also connected to be able to communicate with one or more information sources 105 that are information providers providing various kinds of security information by using an appropriate communication method.

The information collection unit 101 may be similar to the information collection unit 101 in the security information analysis device 100. In this case, for example, the information collection unit 101 may search a certain information source 105 for a keyword which is security information provided from the evaluation unit 201 (to be described later), and may provide, as the security information, the search result to the evaluation unit 201.

The analysis model storage unit 103 may be similar to the analysis model storage unit 103 in the security information analysis device 100. The analysis model storage unit 103 stores the analysis model generated by the security information analysis device 100 (specifically, the learning unit 102). The security information evaluation device 200 may acquire the analysis model online or offline from the security information analysis device 100.

The evaluation unit 201 analyzes the security information supplied from the security information supply unit 202 (to be described later) by using the analysis model stored in the analysis model storage unit 103. More specifically, the evaluation unit 201 gives, as an input, the security information supplied from the security information supply unit 202 to the analysis model, and acquires the weight for each crawler 101 calculated by the analysis model.

For example, the evaluation unit 201 executes information collection processing regarding the security information input to the information source 105 by using the crawler 101 having the largest weight. The evaluation unit 201 can repeatedly execute the above processing by giving, as an input, new security information obtained by the information collection processing to the analysis model.

Accordingly, the evaluation unit 201 can acquire a series of pieces of other security information useful for countermeasures against the security event from the security information regarding the security event given as the input. The evaluation unit 201 may provide, as an analysis result, the series of pieces of security information acquired by the above processing. A specific operation of the evaluation unit 201 will be described later.

The security information supply unit 202 receives the security information to be evaluated and supplies the security information to the evaluation unit 201. The security information supply unit 202 can receive security information regarding a newly occurred security event which is not included in the training data from the outside such as a user or another system.

The evaluation result providing unit 203 provides, as the evaluation result regarding the security information, the analysis result regarding certain security information supplied by the evaluation unit 201 to the outside of the security information evaluation device (for example, a user, another system, or the like). As a specific example, the evaluation result providing unit 203 may display the evaluation result on a screen, may print the evaluation result via a printing device, may output the evaluation result to a storage medium, or may transmit the evaluation result via a communication line. A method for outputting the evaluation result in the evaluation result providing unit 203 is not particularly limited.

Hereinafter, the information analysis system according to the present exemplary embodiment will be described. In the present exemplary embodiment, for example, as illustrated in FIG. 3, the security information analysis system 300 may be constituted by using the security information analysis device 100 and the security information evaluation device 200. In the security information analysis system 300 illustrated in FIG. 3, the security information analysis device 100 and the security information evaluation device 200 are connected to be able to communicate by using an appropriate communication method.

Training data is supplied from the outside to the security information analysis device 100 in the security information analysis system 300 (a user, another system, or the like). The security information analysis device 100 may learn the analysis model by using the training data, and may provide the learned analysis model to the security information evaluation device 200.

Security information to be evaluated is supplied from the outside (a user, another system, or the like) to the security information evaluation device 200 in the security information analysis system 300. The security information evaluation device 200 generates the evaluation result regarding the supplied security information by using the learned analysis model. The learning processing in the security information analysis device 100 and the analysis processing in the security information evaluation device 200 may be individually executed.

The security information analysis system 300 according to the present exemplary embodiment is not limited to the configuration illustrated in FIG. 3. For example, a security information analysis system 400 may be constituted as illustrated in FIG. 4. FIG. 4 illustrates a functional configuration of a system in which the constituent components of the security information analysis device 100 illustrated in FIG. 1 and the constituent components of the security information evaluation device 200 illustrated in FIG. 2 are integrated. In the configuration illustrated in FIG. 4, the learning processing in the learning unit 102 and the analysis processing in the evaluation unit 201 may be individually executed. The security information analysis device 100 and the security information evaluation device 200 according to the present exemplary embodiment may be realized as individual devices, or may be realized as a part of the system illustrated in FIG. 3 or 4.

### [Training Data]

Next, training data will be described. As described above, in the present exemplary embodiment, training data including security information useful for countermeasures regarding a certain security event is provided. Hereinafter, for the sake of convenience in description, it is assumed that the training data is provided as text data (character string data). However, the training data may be image data or the like.

In the present exemplary embodiment, an appropriate number of training data is prepared in advance. The number of training data may be appropriately selected. For example, about several thousands to million pieces of training data can be prepared by creating pieces of training data from pieces of information provided by various security-related companies or organizations, and the like.

The training data includes one or more pieces of security information regarding a security event. Typically, the training data includes security information (for example, information indicating a sign of a malware attack) that can be a trigger for a certain security event and security information that is determined to be useful for a countermeasure for a security event.

When another security information included in the same training data can be acquired by repeating the information collection processing with the security information included in a certain training data as a trigger, it is considered that the security information useful in the procedure of such information collection processing is obtained. Hereinafter, one piece of security information included in the training data may be referred to as a “sample”.

The sample includes specific data indicating the security information. As a specific form, a certain sample may include data (type data) indicating a “type” of the security information, data (semantic data) indicating a “meaning” of the security information, and data (value data) indicating a value of the security information.

The type data is data indicating a category, a format, and the like of the security information. For example, when certain security information is the IP address, an identifier indicating an “IPv4 address”, an identifier indicating an “IPv6 address”, or the like may be set in the type data in accordance with the content thereof.

The semantic data is data indicating the meaning indicated by the security information. For example, when certain security information is the IP address, an identifier indicating “data transmission source”, “data transmission destination”, “monitoring target IP address”, or the like may be set in the semantic data in accordance with the content of the security information.

The value data is data indicating a specific value of the security information. For example, when certain security information is the IP address, a specific IP address value may be set to the value data.

The present invention is not limited to the above example, and the sample may further include other data. In some cases, at least one of the type data and the semantic data may not be included in the sample.

As the classification of the type data and the semantic data, a classification according to a unique standard may be adopted, or a well-known classification may be adopted. For example, a “DatatypeEnum” type defined in Structured Threat Information eXpression (STIX)/Cyber Observable eXpression (CybOX) studied in Organization for the Advancements of Structured Information Standards (OASIS) may be adopted as an example of the type data. Vocabularies defined in the STIX/CybOX may be adopted as an example of the semantic data.

The format expressing the training data is not particularly limited, and an appropriate format may be selected. As a specific example, the training data according to the present exemplary embodiment is expressed by using a JavaScript (registered trademark) Object Notation (JSON) format. Another format (for example, Extensible Markup Language (XML)) or the like capable of structurally expressing the data may be adopted as the format expressing the training data.

### [Learning Method of Analysis Model]

A method for learning the analysis model constructed as described above will be described.

The learning unit 102 according to the present exemplary embodiment can express a learning procedure as a graph. Hereinafter, the graph representing the learning procedure may be referred to as a learning graph.

Each node of the learning graph has at least one or more pieces of security information. In the learning procedure to be described later, a node including the security information supplied as an input to the learning unit 102 is referred to as an input node. For the security information of the input node, a node including one or more pieces of security information acquired by the crawler 101 selected by the learning unit 102 executing the information collection processing is referred to as an output node. The output node is input, as an input node at a next stage of the learning procedure, to the learning unit 102.

When the learning processing related to certain training data is started, a node including, as a first input, the security information supplied to the learning unit 102 may be referred to as an initial node. The security information included in the input node may be referred to as input security information, and the security information included in the output node may be referred to as output security information.

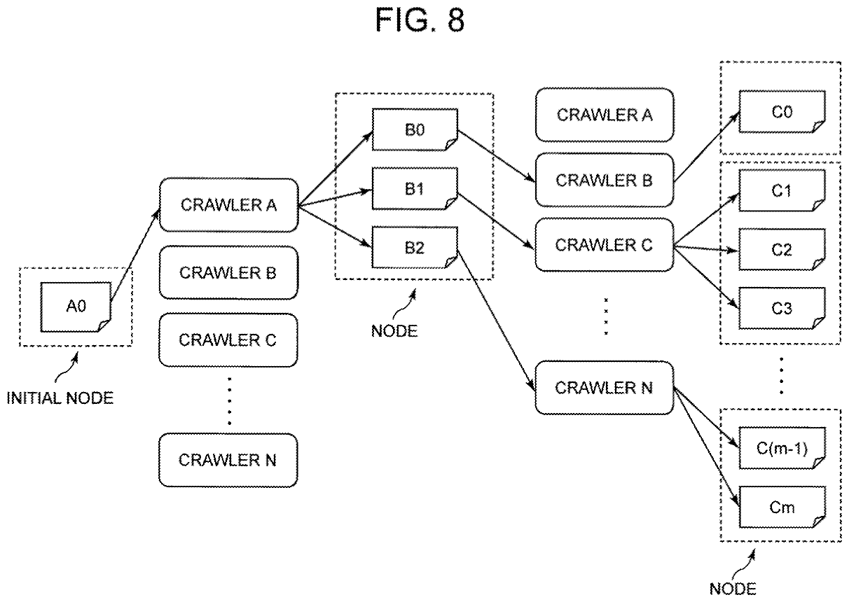

FIG. 8 is an explanatory diagram conceptually illustrating an example of the learning graph. Hereinafter, an outline of the learning graph according to the present exemplary embodiment will be described with reference to the explanatory diagram illustrated in FIG. 8. The learning graph illustrated in FIG. 8 is an example, and the present exemplary embodiment is not limited thereto.

As described above, the security information regarding a certain security event is given, as the training data, to the learning unit 102. For example, the learning unit 102 may handle the given security information as the initial node illustrated in FIG. 8.

In the learning procedure of the analysis model, the learning unit 102 receives, as an input, security information included in a certain input node, and outputs information (weight of the crawler 101) for selecting the crawler 101 that executes the information collection processing using the security information.

In the specific example illustrated in FIG. 8, for example, the learning unit 102 gives, as an input, the security information (for example, “A0”) included in the input node to the analysis model. The analysis model calculates the weight of each crawler 101 corresponding to the given security information. In accordance with the output (weight) calculated by the analysis model, the learning unit 102 selects the crawler 101 (for example, “crawler A”) that executes the information collection processing related to the security information (“A0”).

The learning unit 102 further executes information collection processing in the information source 105 by using the selected crawler 101, and acquires new security information. The case of FIG. 8 indicates that “B0” to “B2” are newly obtained as the security information as a result of the learning unit 102 executing the information collection processing by using “crawler A”.

The learning unit 102 repeatedly executes the above processing until an end condition of the learning processing is satisfied. For example, the case of FIG. 8 indicates that the learning unit 102 selects “crawler B” for the security information “B0”, executes the information collection processing, and obtains security information “C0”. Similarly, the case of FIG. 8 indicates that the learning unit 102 selects “crawler C” and “crawler N” for the pieces of security information “B1” and “B2”, and obtains pieces of security information “C1” to “C3” and “C(m−1)” and “Cm” as a result of the information collection processing by this selection.

As described above, the learning unit 102 repeats the processing of acquiring new security information by inputting the security information to the crawler 101 which is the search means and searching for another new security information by inputting the acquired security information to the crawler 101.

The learning unit 102 adjusts a coupling parameter between the units in the analysis models (the first model and the second model) in accordance with the security information acquired in each of the above repetition stages. In the case of FIG. 8, for example, the parameter of the analysis model is adjusted in accordance with each piece of security information acquired before the pieces of security information “C0” to “Cm” are obtained from the security information “A0” given as the training data.

Any method is used as the method for learning the analysis model, and for example, a framework of Q-learning which is one method of reinforcement learning described in PTL 3 or NPL 1 may be used. Due to the use of the framework of the Q-learning, for example, when the security information not acquired between the initial node and the input node is obtained as the output node, it is possible to set a higher score (reward) than other nodes.

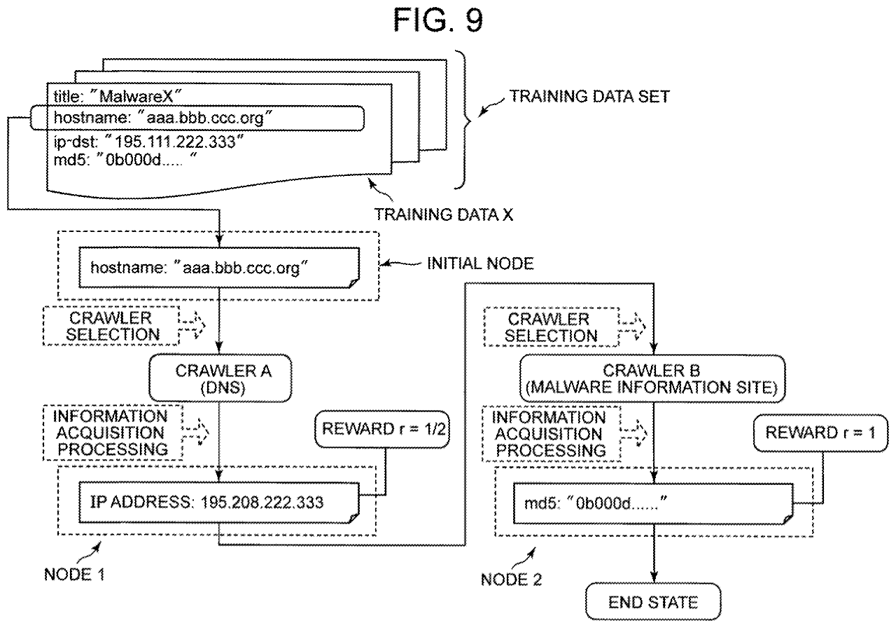

Hereinafter, the learning method by the learning unit 102 will be described by using a specific example. FIG. 9 is an explanatory diagram illustrating an example of the learning procedure of the analysis model.

The learning unit 102 selects certain training data (referred to as training data X.) from a plurality of training data sets. In the specific example illustrated in FIG. 9, the training data X includes three pieces of security information (hostname, ip-dst, and- md5).

The learning unit 102 selects one piece of security information (samples) included in the training data X. In the specific example illustrated in FIG. 9, “hostname” is selected. The selected security information is handled as the initial node.

The learning unit 102 selects the initial node as the input node, and selects the crawler 101 that executes the information collection processing related to the security information included in the input node. At this time, the learning unit 102 may randomly select the crawler 101. The learning unit 102 may convert the input node into an appropriate format (for example, the JSON format), may input the input node to the analysis model at this timing, and may select the crawler 101 having the largest value (weight) output from the analysis model.

In the case of FIG. 9, the crawler 101 (crawler A illustrated in FIG. 9) that executes the information collection processing by using the DNS is selected. The crawler A acquires the IP address (“195.208.222.333”) corresponding to the host name (“aaa.bbb.ccc.org”) of the input node by using the DNS, and provides the IP address to the learning unit 102. The learning unit 102 generates the output node by using the result of the information collection processing (node 1 illustrated in FIG. 9).

The learning unit 102 calculates a reward for the selection of the crawler A and the information collection processing. In this case, among the pieces of security information included in the training data X, the total number of pieces of security information not included between the initial node and the output node (node 1) is 1 (“md5”). Accordingly, the learning unit 102 calculates “r=1/(1+1)=½” for the reward “r”. In the example illustrated in FIG. 9, the learning unit 102 determines that a next state of the node 1 is not an end state.

For example, the learning unit 102 may store transition data (state “s” (initial node), action “a” (crawler A), reward “r”(“r=½”), next state “s′”(node 1)) obtained by the above processing as transition data for learning. The transition data may be referred to as a route.

The learning unit 102 executes processing similar to the above processing with the node 1 as the input node. In the example illustrated in FIG. 9, the crawler B is selected as the crawler 101. For example, the crawler B searches for an IP address included in the node 1 at an external site that provides malware information, and acquires the search result. In the case of FIG. 9, a hash value (for example, a value of Message Digest Algorithm 5 (MD5)) of a malware file is obtained as the search result. The learning unit 102 generates the output node by using the result of such information collection processing (node 2 illustrated in FIG. 9).

The learning unit 102 calculates a reward for the selection of the crawler B and the information collection processing. In this case, among the pieces of security information included in the training data X, the total number of pieces of security information not included between the initial node and the output node (node 2) is 0. Thus, the learning unit 102 calculates “r=1/(0+1)=1” for the reward “r”. Since the reward r satisfies “r=1”, the learning unit 102 determines that a next state of the node 2 is an end state.

For example, the learning unit 102 may store the transition data (state “s” (node 1), action “a” (crawler B), reward “r” (“r=1”), next state “s′” (node 2)) obtained by the above processing as the transition data for learning. At this time, the learning unit 102 may calculate a value to be a teaching signal by using the transition data for learning. At this time, the learning unit 102 may calculate a value that can be a teaching signal by using the transition data for learning, and may store the value in association with the transition data.

By the processing as described above, the learning unit 102 can generate the transition data. In this procedure, the learning unit 102 can generate the learning graph.

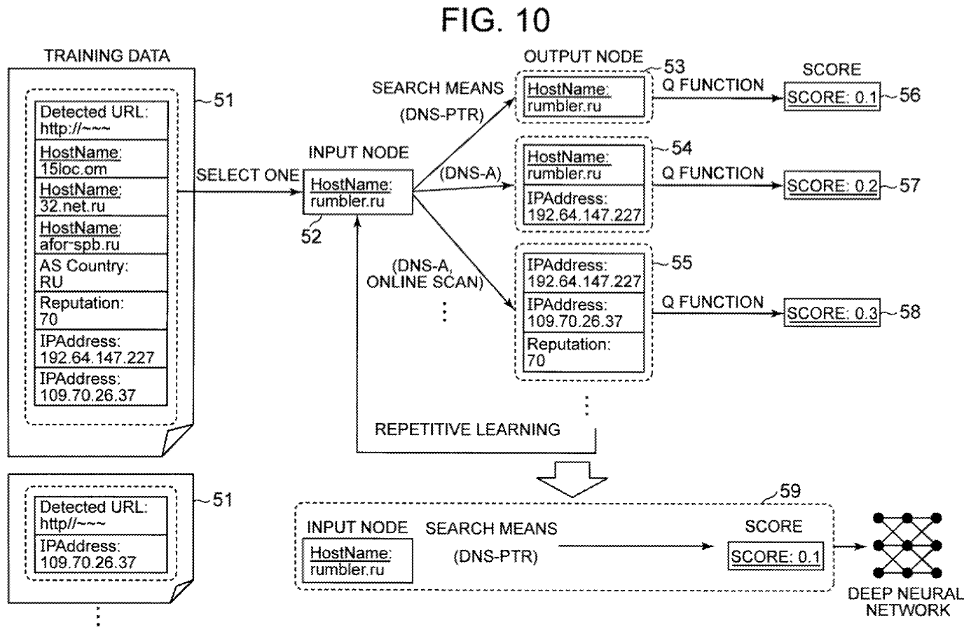

FIG. 10 is an explanatory diagram illustrating an example of a relationship between the learning graph illustrated in FIG. 8 and the training data to be selected. The learning unit 102 optionally selects, as an input node, one piece of training data 52 from the training data 51. The learning unit 102 performs the information collection processing by using the search means prepared in advance. The example illustrated in FIG. 10 indicates that three types of security information groups 53, 54, and 55 are obtained as output nodes by three types of search means (DNS-PTR, DNS-A, and DNS-A and online scan).

The learning unit 102 calculates a score using a Q function based on the obtained output node. The example illustrated in FIG. 10 indicates that scores 56, 57, and 58 are calculated as 0.1, 0.2, and 0.3, respectively, based on the obtained security information groups 53, 54, and 55 by the three types of search means. The Q function illustrated in FIG. 10 is a function that converts a difference between the security information and the training data from the content and the number of items into a score.

Hereinafter, repetitive learning processing is performed by using the output node as the input node. The learning unit 102 learns the analysis model constituted by a deep neural network, for example, by using data 59 to which a score is assigned in accordance with the combination of the input node and the search means.

In the present exemplary embodiment, the learning unit 102 suppresses information collection processing that does not contribute to the acquisition of the useful security information in each of the above-described repetition stages. Specifically, when the route of the search means used for a series of searches for the security information includes a combination defined by the simplification information, the learning unit 102 changes the search for the security information to a search corresponding to the method indicated by the simplification information.

That is, when the transition data includes the combination defined by the simplification information, the learning unit 102 changes the information collection processing by the combination to be simplified. As described above, since the learning unit 102 performs control such that the search processing by the search means is simplified, the learning unit 102 according to the present exemplary embodiment can also be referred to as control means. The simplification of the information collection processing performed by the learning unit 102 includes control to delete the information collection processing by the search means and control to reduce the number of search means that perform the information collection processing.

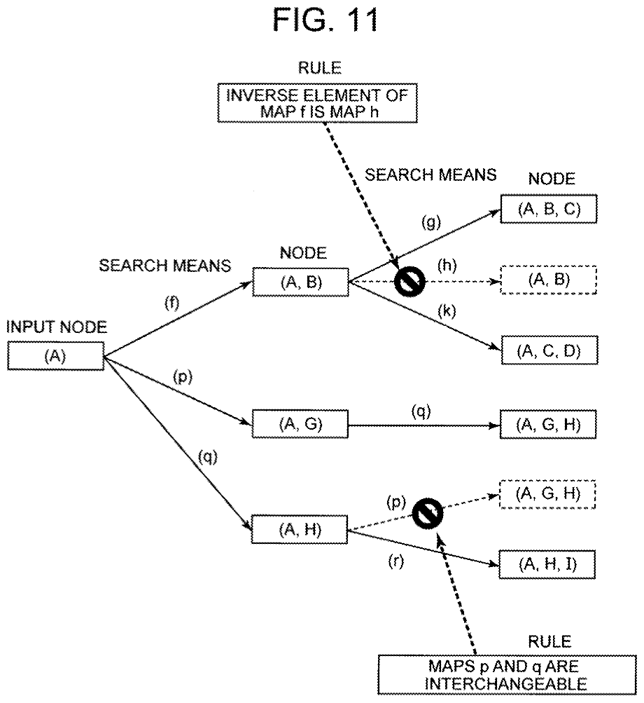

FIG. 11 is an explanatory diagram illustrating an example of processing of suppressing the information collection processing by the search means. For example, as illustrated in FIG. 11, it is assumed that a node (A, B) is obtained by using search means (f) for an input node (A). Here, when it is assumed that an inverse element of a map f is a map h, the obtained node becomes the node (A, B) even though search means (h) is used for the node (A, B). In this case, it can be said that a combination of the search means (f) and the search means (h) is a combination of search means in which the obtained security information does not increase. Thus, the learning unit 102 decides not to perform the information collection processing by the search means (h) after the search means (f) (that is, the route is deleted).

For example, as illustrated in FIG. 11, it is assumed that a node (A, G) is obtained by using search means (p) for the input node (A), and a node (A, G, H) is obtained by using search means (q) for a node (A, G). It is assumed that a node (A, H) is obtained by using the search means (q) for the input node (A). Here, when maps p and q are interchangeable, the obtained node becomes a node (A, B, H) even though the search means (p) is used for the node (A, H). In this case, it can be said that a combination of the search means (q) and the search means (p) is a combination of search means in which the obtained security information does not increase. Thus, the learning unit 102 decides not to collect information by the search means (p) after the search means (q) (that is, the route is deleted).

The processing of changing the search by the learning unit 102 based on the simplification information can be generalized as follows. It can be said that a full search is to obtain an output c=tr_{R}(a), ∃ c ∈ Bₙ from a route tr_{R}=fₙ◯ . . . ◯f₁ for the start a ∈A, a route R={<f₁, fₙ>|fₙ ∈ Hom(C)}.

Depending on the type of the search, B may be a power set {Xi ⊆X|i ∈I}→B=U_{i∈I}Xᵢ.→represents an original correspondence. Since a power set p is a monad, when a simple function is set as an operator ◯, p(x◯y)=p(x)◯p(y). A function q that creates a tuple from an input and an output of the function is also a monad, and q(x◯y)=q(x)◯q(y). Thus, an arithmetic operation of p and q can be handled separately from the function. Accordingly, regardless of whether or not B is the power set, the map f is simply handled as f: A→B.

Under such generalization, in the present exemplary embodiment, the learning unit 102 reduces learning cost by extracting a partial route satisfying dom(R)=dom(R′) and cod(R)=cod(R′) which are equivalent to the learning result and simplifying R having the smallest set of maps. When the unit element is ε, the learning unit 102 reduces the learning cost by deleting a partial route satisfying fₙ◯ . . . ◯f₁=ε.

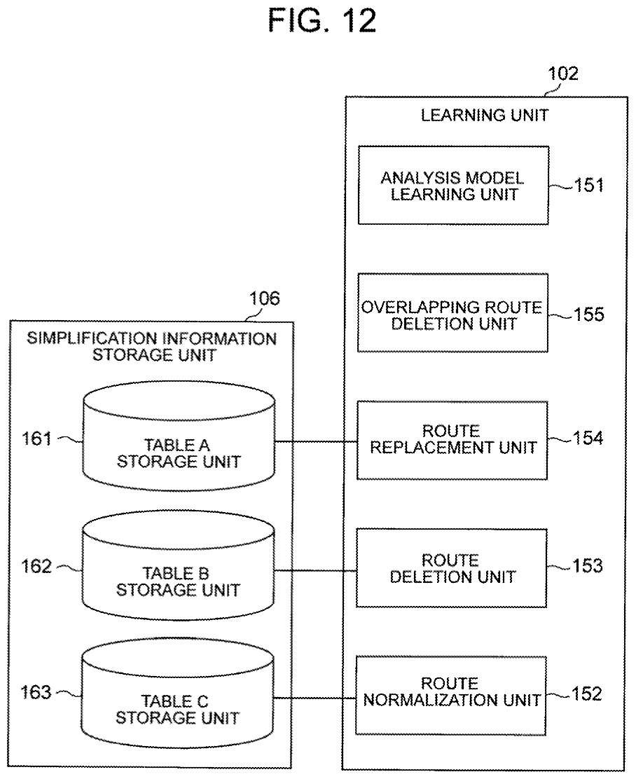

Hereinafter, the processing of the learning unit 102 will be described in detail with an example in which the simplification information storage unit 106 stores three types of tables (Table A, Table B, and Table C) illustrated in FIG. 7. FIG. 12 is a block diagram illustrating an example of a specific configuration of the learning unit 102 and the simplification information storage unit 106. The learning unit 102 illustrated in FIG. 12 includes an analysis model learning unit 151, a route normalization unit 152, a route deletion unit 153, a route replacement unit 154, and an overlapping route deletion unit 155. The simplification information storage unit 106 includes a table A storage unit 161, a table B storage unit 162, and a table C storage unit 163.

The analysis model learning unit 151 performs the learning processing described above. The table A storage unit 161, the table B storage unit 162, and the table C storage unit 163 store Table A, Table B, and Table C illustrated in FIG. 7, respectively.

The route normalization unit 152 refers to the table C storage unit 163 that retains the combinations of the interchangeable maps (search means), and sorts the combination portions in lexical order when the combination defined as the interchangeable maps is included in the route. Such normalization is performed, and thus, the information of the information combinations stored in Table A and Table B can be reduced.

The route deletion unit 153 refers to the table B storage unit 162 that retains a combination (that is, a combination of search means) of maps in which synthesis is the unit element ε, and deletes the combination from the route when the combination of the search means that can be simplified so as to delete the information collection processing by the search means is included in the route.

The route replacement unit 154 refers to the table A storage unit 161 that retains a combination (that is, a combination of search means; hereinafter, referred to as a second combination) of the maps replaceable with the combination (hereinafter, referred to as a first combination) for reducing the number of search means that perform the information collection processing, and replaces the second combination with the first combination when the second combination is included in the route.

When an overlapping combination is included in the route, the overlapping route deletion unit 155 deletes one of the combinations.

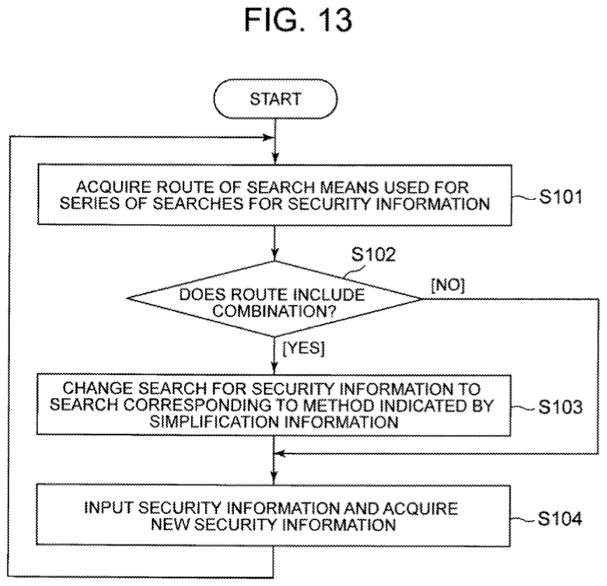

FIG. 13 is a flowchart illustrating an operation example of the security information analysis device according to the present exemplary embodiment. The learning unit 102 acquires a route of search means used for a series of searches for the security information (step S101). When the acquired route includes the combination defined by the simplification information (YES in step S102), the learning unit 102 changes the search for the security information to the search corresponding to the method indicated by the simplification information (step S103). On the other hand, when the acquired route does not include the combination defined by the simplification information (NO in step S102), the learning unit 102 performs the processing in and after step S104.

The learning unit 102 inputs the security information to the search means and acquires new security information (step S104). Thereafter, the learning unit 102 repeats the processing in and after step S101 of searching for another new security information by inputting the acquired security information to the search means.

Next, a procedure for analyzing security information related to certain security information by the evaluation unit 201 in the security information evaluation device 200 by using the analysis model learned as described above will be described.

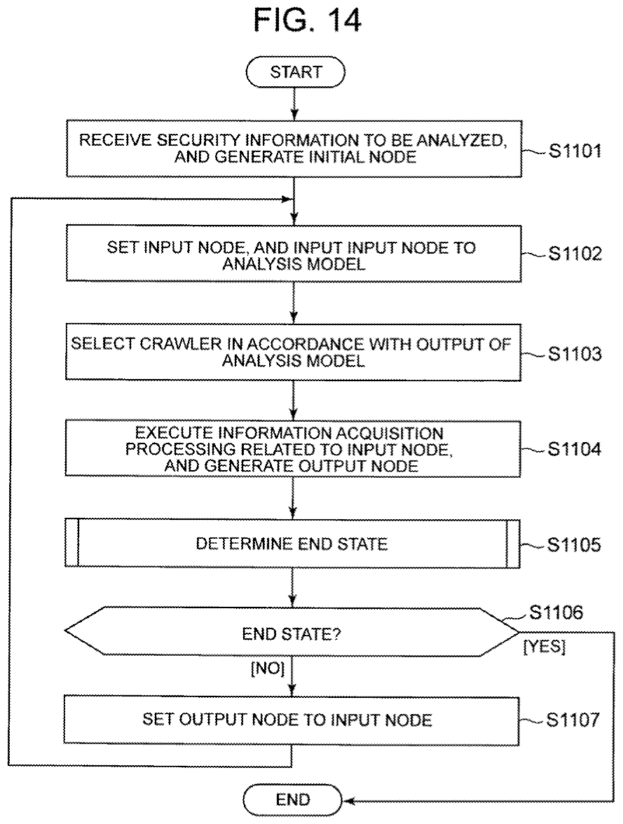

FIG. 14 is a flowchart illustrating an operation example of the evaluation unit 201. In the following description, it is assumed that the learned analysis model is disposed in the analysis model storage unit 103 in the security information evaluation device 200.

For example, the evaluation unit 201 receives security information to be newly analyzed from the security information supply unit 202, and generates an initial node (step S1101). The initial node is handled as an initial input node.

The evaluation unit 201 sets the input node and supplies the security information included in the input node to the analysis model (step S1102). At this time, the evaluation unit 201 may convert the security information into an appropriate format. The analysis model calculates a value representing the weight for each crawler 101 in accordance with the input.

The evaluation unit 201 selects the crawler 101 having the largest weight among the outputs of the analysis model (step S1103).

The evaluation unit 201 generates an output node including new security information acquired by executing the information collection processing related to the security information included in the input node by using the selected crawler 101 (step S1104).

The evaluation unit 201 determines whether or not a next state of the output node is an end state (step S1105).

For example, when tasks of processing in steps S1102 to S1104 are executed a predetermined number of times or more for the security information received in step S1101, the evaluation unit 201 may determine that the next state of the output node in step S1104 is the end state.

For example, when the weight of the crawler 101 (end processing crawler) transitioning to the end state is the largest among the weights calculated by the analysis model, the evaluation unit 201 may determine that the next state of the output node in step S1104 is the end state.

When it is determined that the next state of the output node is not the end state (NO in step S1106), the evaluation unit 201 sets the output node generated in step S1104 as a new input node, and continues the processing from step S1102. Accordingly, the information collection processing is repeatedly executed in accordance with the security information provided in step S1101.

When it is determined that the next state of the output node is the end state (YES in step S1106), the evaluation unit 201 ends the processing. The evaluation unit 201 may provide information indicating the nodes generated from the initial node to the final output node to the evaluation result providing unit 203.

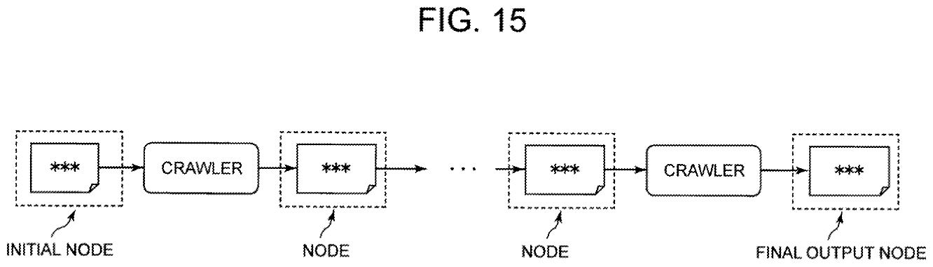

More specifically, the evaluation unit 201 may generate a graph (evaluation graph) connecting the generated nodes from the initial node to the final output node, and may provide the graph to the evaluation result providing unit 203. FIG. 15 is an explanatory diagram illustrating an example of the generated evaluation graph. The evaluation graph illustrated in FIG. 15 represents a connection relationship between the node, the crawler that performs the information collection processing based on the node, and the node output by the crawler. The evaluation result providing unit 203 may generate the evaluation graph.

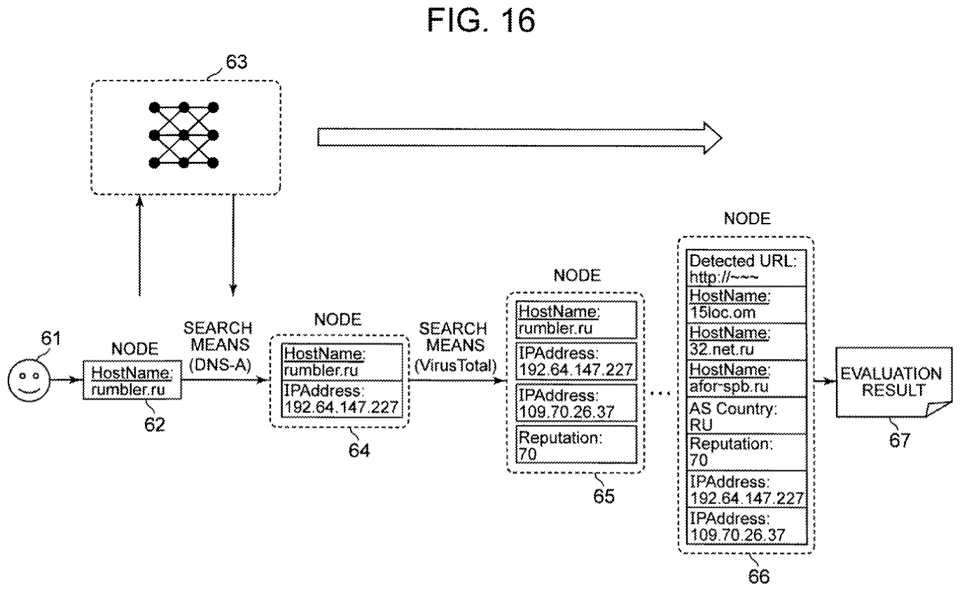

FIG. 16 is an explanatory diagram illustrating an example of specific processing of the evaluation. When the user or another system 61 inputs security information (node) 62 to the security information supply unit 202, the evaluation unit 201 specifies search means having the highest score by using an analysis model 63. The evaluation unit 201 acquires a new node 64 by performing the information collection processing by using the specified search means. The evaluation unit 201 specifies search means for the acquired new node 64 by using the analysis model 63, and acquires an additional node 65. Hereinafter, the evaluation unit 201 performs evaluation processing using the analysis model 63 until a combination of search means having a certain score or more can be acquired or the number of times of repetitions reaches a certain number of times. The evaluation result providing unit 203 outputs an evaluation result 67 based on the finally acquired node 66.

As described above, the evaluation unit 201 repeats processing of selecting search means in accordance with the weight calculated by applying the security information (node) to the analysis model and processing of acquiring another security information by using the selected search means. The evaluation result providing unit 203 generates the route based on the acquired security information. The evaluation result providing unit 203 may generate, for example, the route illustrated in FIG. 15.

According to the security information analysis device 100 according to the present exemplary embodiment described above, the analysis model learned is learned by using the training data described above, and thus, it is possible to collect the useful security information even for, for example, the security event that is not included in the training data. This is because the analysis model is learned to output a large weight to the information collection processing (crawler 101) capable of acquiring other useful security information from security information regarding a certain security event.

Since it is considered that the determination result (knowledge) of the usefulness regarding the security information is reflected in the training data, it is considered that the knowledge of the usefulness regarding the security information is reflected in the output of the analysis model.

In the present exemplary embodiment, the analysis model is learned such that the information collection processing (crawler 101) capable of acquiring another security information included in the same training data is easily selected from certain security information included in the training data. Accordingly, the information collection processing capable of acquiring another security information is selected one after another from the security information as a trigger for a certain security event. As a result, the analysis model can learn the procedure of the information collection.

In the present exemplary embodiment, it is possible to relatively easily prepare a large amount of training data. This is because the security information as a trigger for a certain security event and the security information of which the usefulness is determined can be relatively easily prepared based on, for example, a report or the like provided by a company, an organization, or the like related to security.

According to the security information evaluation device 200 according to the present exemplary embodiment, for example, even when a new security event occurs and only a small amount of information are initially obtained, it is possible to collect useful information regarding the security event by using the analysis model learned as described above. It is possible to collect useful security information without depending on knowledge, experience, or the like of the person in charge of security or the like by using the security information evaluation device 200.

The security information evaluation device 200 according to the present exemplary embodiment can present the evaluation graph indicating the evaluation result of certain security information to the user. The user can verify validity of the collected security information by checking not only the finally collected security information but also the collection procedure thereof for a certain security event.

As described above, according to the present exemplary embodiment, it is possible to easily acquire useful security information regarding a certain security event. That is, it is possible to shorten a time for collecting useful threat information regarding security used in machine learning. It is possible to suppress a time required for learning the analysis model which is about three months in the method described in PTL 3 to about two weeks (about 15%) by using the security information analysis device according to the present exemplary embodiment.

### <Configuration of Hardware and Software Program (Computer Program)>

Hereinafter, a hardware configuration capable of realizing the above-described exemplary embodiments and modification examples will be described.

Each device and system described in each of the above exemplary embodiments may be constituted by one or a plurality of dedicated hardware devices. In this case, the constituent components illustrated in each of the above drawings may be realized as hardware (an integrated circuit or the like on which a processing logic is implemented) in which a part or all of the constituent components are integrated.

For example, when each device and system is realized by hardware, the constituent components of each device and system may be implemented as an integrated circuit (for example, a system on a chip (SoC) or the like) capable of providing the functions. In this case, for example, data included in the constituent components of each device and system may be stored in a random access memory (RAM) region or a flash memory region integrated as an SoC.

In this case, a communication network including a known communication bus may be adopted as a communication line that connects the constituent components of each device and system. The communication line connecting the constituent components may connect the constituent components in a peer-to-peer manner. When each device and system is constituted by a plurality of hardware devices, the hardware devices may be connected to be able to communicate by an appropriate communication method (wired, wireless, or a combination thereof).

For example, each device and system may be realized by using a processing circuit and a communication circuitry that realize the function of the information collection unit (crawler) 101, a processing circuitry that realizes the function of the learning unit 102, a storage circuitry that realizes the analysis model storage unit 103, a processing circuitry that realizes the function of the training data supply unit 104, a storage circuitry that realizes the simplification information storage unit 106, and the like.

Each device and system may be realized by using a processing circuitry that realizes the function of the evaluation unit 201, a processing circuitry that can realize the function of the security information supply unit 202, a processing circuitry that can realize the function of the evaluation result providing unit 203, and the like. The above circuitry configuration is one specific aspect, and various variations are assumed in the implementation.

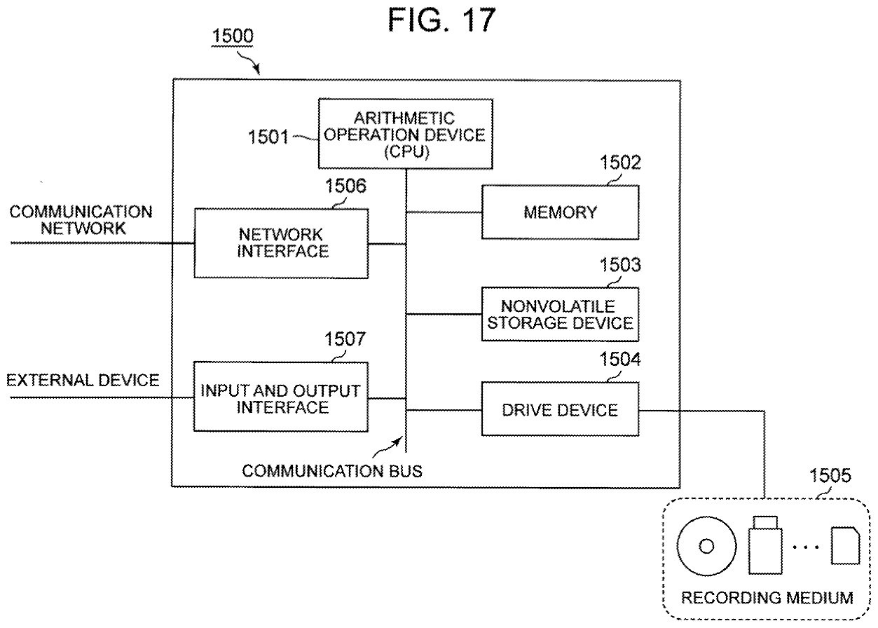

Each of the above-described devices and systems may be constituted by a general-purpose hardware device and various software programs (computer programs) executed by the hardware device. FIG. 17 is an explanatory diagram illustrating a configuration example using the general-purpose hardware device. In this case, each device and system may be constituted by one or more appropriate numbers of hardware devices 1500 and software programs.

An arithmetic operation device 1501 (processor) in FIG. 17 is an arithmetic processing device such as a general-purpose central processing unit (CPU) or a microprocessor. For example, the arithmetic operation device 1501 may read various software programs stored in a nonvolatile storage device 1503 to be described later into a memory 1502 and execute processing according to the software programs. In this case, the constituent components of each device and system according to each of the above exemplary embodiments can be realized as, for example, a software program executed by the arithmetic operation device 1501.

For example, each device and system may be realized by using a program for realizing the function of the information collection unit (crawler) 101, a program for realizing the function of the learning unit 102, a program for realizing the function of the training data supply unit 104, and the like.

Each device and system may be realized by using a program that realizes the function of the evaluation unit 201, a program that can realize the function of the security information supply unit 202, a program that can realize the function of the evaluation result providing unit 203, and the like. The program configuration is one specific aspect, and various variations are assumed in the implementation.

The memory 1502 is a memory device such as a RAM that can be referred to from the arithmetic operation device 1501, and stores software programs, various data, and the like. The memory 1502 may be a volatile memory device.

The nonvolatile storage device 1503 is a nonvolatile storage device such as a magnetic disk drive or a semiconductor storage device using a flash memory. The nonvolatile storage device 1503 can store various software programs, data, and the like. In each of the above-described devices and systems, the analysis model storage unit 103 and the simplification information storage unit 106 may store the analysis model in the nonvolatile storage device 1503.

A drive device 1504 is, for example, a device that processes reading and writing of data on a recording medium 1505 to be described later. The training data supply unit 104 in each of the above-described devices and systems may read the training data stored in the recording medium 1505 to be described later via the drive device 1504, for example.

The recording medium 1505 is a recording medium capable of recording data, such as an optical disk, a magneto-optical disk, or a semiconductor flash memory. In the present disclosure, a type of the recording medium and a recording method (format) are not particularly limited, and can be appropriately selected.

A network interface 1506 is an interface device connected to a communication network, and for example, a wired or wireless local area network (LAN) connection interface device or the like may be adopted. For example, the information collection unit 101 (crawler 101) in each of the above-described devices and systems may be connected to be able to communicate with the information source 105 via the network interface 1506.

An input and output interface 1507 is a device that controls input and output to and from an external device. The external device may be, for example, an input device (for example, a keyboard, a mouse, a touch panel, or the like) capable of receiving an input from the user. The external device may be, for example, an output device (for example, a monitor screen, a touch panel, or the like) capable of presenting various outputs to the user.

For example, the security information supply unit 202 in each of the above-described devices and systems may receive new security information from the user via the input and output interface 1507. For example, the evaluation result providing unit 203 in each of the above-described devices and systems may provide the evaluation result to the user via the input and output interface 1507.

Each device and system according to the present invention described using each exemplary embodiment described above as an example may be realized, for example, by supplying a software program capable of realizing the functions described in each exemplary embodiment to the hardware device 1500 illustrated in FIG. 17. More specifically, for example, the present invention may be realized by the arithmetic operation device 1501 executing the software program supplied to the hardware device 1500. In this case, an operating system operating in the hardware device 1500, middleware such as database management software or network software, or the like may execute a part of each processing.

In each of the above-described exemplary embodiments, each unit illustrated in each of the above-described drawings (for example, FIGS. 1 to 4 and 12) can be realized as a software module which is a functional (processing) unit of the software program executed by the above-described hardware. However, the division of each software module illustrated in these drawings is a configuration for the sake of convenience in description, and various configurations can be assumed in the implementation.

For example, when the above-described units are realized as the software modules, these software modules may be stored in the nonvolatile storage device 1503. When the arithmetic operation device 1501 executes each processing, these software modules may be read into the memory 1502.

These software modules may be configured to be able to mutually transmit various kinds of data by an appropriate method such as a shared memory or inter-process communication. With such a configuration, these software modules are connected to be able to communicate with each other.

Each software program may be recorded in the recording medium 1505. In this case, each software program may be configured to be appropriately stored in the nonvolatile storage device 1503 through the drive device 1504 at a shipping stage, an operation stage, or the like of the communication device or the like.

In the above-described case, a method for installing the programs on the hardware device 1500 by using an appropriate jig (tool) in a manufacturing stage before shipment, a maintenance stage after shipment, or the like may be adopted as a method for supplying various software programs to the above-described devices and systems. A general procedure such as a method for downloading the programs from the outside via a communication line such as the Internet may be adopted as the method for supplying various software programs.

In such a case, the present invention can be regarded as being a code constituting such a software program or a computer-readable recording medium in which the code is recorded. In this case, the recording medium is not limited to the medium independent of the hardware device 1500, and includes a storage medium that downloads and stores or temporarily stores a software program transmitted via a LAN, the Internet, or the like.

Each of the above-described devices and systems or the constituent components of each of the devices and systems may be constituted by a virtualized environment obtained by virtualizing the hardware device 1500 illustrated in FIG. 17 and various software programs (computer programs) executed in the virtualized environment. In this case, the constituent components of the hardware device 1500 illustrated in FIG. 17 are provided as virtual devices in the virtualization environment. In this case, the present invention can also be realized with a configuration similar to the case where the hardware device 1500 illustrated in FIG. 17 is constituted by a physical device.

The present invention has been described above as the example applied to the exemplary embodiment described above. However, the technical scope of the present invention is not limited to the scope described in each of the above-described exemplary embodiments. It is apparent to those skilled in the art that various changes or improvements can be made to the above-described exemplary embodiments. In such a case, new exemplary embodiments with changes or improvements can also be included in the technical scope of the present invention. The technical scope of the present invention may include each of the above-described exemplary embodiments or an exemplary embodiment obtained by combining new exemplary embodiments to which such changes or improvements are added. This is apparent from the matters described in the claims.

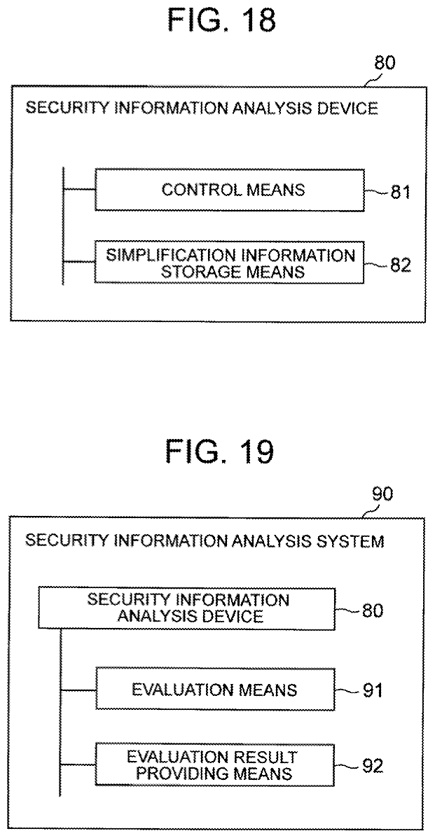

Next, an outline of the present invention will be described. FIG. 18 is a block diagram illustrating an outline of the security information analysis device according to the present invention. A security information analysis device 80 (for example, the security information analysis device 100) according to the present invention includes control means 81 (for example, the learning unit 102) that repeats the processing of acquiring the new security information by inputting the security information to the search means (for example, the information collection unit 101 or the crawler 101) for receiving the input information and searching for the security information from the information provider (for example, the information source 105) that provides the security information indicating the information regarding the security event and acquiring another new security information by inputting the acquired security information to the search means, and simplification information storage means 82 (for example, the simplification information storage unit 106) for storing the simplification information defining the method for simplifying the combination of the search means in which the obtained security information does not increase.

When the route of the search means used for the series of searches for the security information includes the combination defined by the simplification information, the control means 81 changes the search for the security information to the search corresponding to the method indicated by the simplification information.

With such a configuration, useful information regarding security can be efficiently collected.

The security information analysis device 80 may include a learning unit (for example, the learning unit 102) that creates an analysis model for calculating a weight regarding one or more search means in accordance with the security information received as an input. The learning unit may learn the analysis model such that the weight of the search means capable of acquiring another security information included in one piece of training data from the information provider increases in accordance with the security information included in the training data by using the training data including the plurality of pieces of security information acquired (by the control means 81).

That is, since the learning unit learns the analysis model based on the efficiently collected information, it is possible to perform learning with further reduced cost.

Specifically, when the route includes the combination of search means (for example, the information in Table B) that can be simplified so as to delete the information collection processing by the search means, the control means 81 may delete the combination from the route.

When the route includes the second combination (for example, the information in Table A) that is the combination of search means that can be replaced with the first combination that is the combination for reducing the number of search means that perform the information collection processing, the control means 81 may replace the second combination with the first combination.

When the combination (for example, the information in Table C) defined as the interchangeable search means is included in the route, the control means 81 may sort portions of the combination in lexical order.

The control means 81 may delete one of the combinations of the overlapping search means included in the route.

More preferably, the control means 81 may sort portions of the combination in lexical order when the combination defined as the interchangeable search means is included in the route, may delete the combination from the route when the combination of search means that can be simplified so as to delete the information collection processing by the search means is included in the sorted route, may replace the second combination with the first combination when the second combination that is the combination of search means that can be replaced with the first combination that is the combination for reducing the number of search means that perform the information collection processing is included in the route in which the combination is deleted, and may delete one of the combinations of the overlapping search means included in the replaced route.

FIG. 19 is a block diagram illustrating an outline of the security information analysis system according to the present invention. A security information analysis system 90 (for example, the security information analysis system 300 or 400) according to the present invention includes the security information analysis device 80 described above, evaluation means 91 (for example, the evaluation unit 201) for repeating processing of selecting the search means in accordance with the weight calculated by applying the security information to the analysis model and processing of acquiring another security information by using the selected search means, and evaluation result providing means 92 (for example, the evaluation result providing unit 203) for generating the route based on the acquired security information.

According to such a configuration, a more efficient search route can be provided to the user.

Some or all of the above exemplary embodiments may be described as the following supplementary notes, but are not limited to the following supplementary notes.

(Supplementary note 1) There is provided a security information analysis device including control means for repeating processing of acquiring new security information by inputting security information indicating information regarding a security event to search means for receiving input information and searching for the security information from an information provider that provides the security information and searching for another new security information by inputting the acquired security information to the search means, and simplification information storage means for storing simplification information defining a method for simplifying a combination of search means in which security information to be obtained does not increase. The control means changes the search for the security information to a search corresponding to the method indicated by the simplification information when a route of the search means used for a series of searches for the security information includes the combination defined by the simplification information.
(Supplementary note 2) The security information analysis device according to supplementary note 1 further includes a learning unit that creates an analysis model for calculating a weight related to one or more search means in accordance with security information received as an input. The learning unit learns the analysis model such that the weight of the search means capable of acquiring another security information included in one piece of training data including a plurality of pieces of the acquired security information from the information provider increases in accordance with the security information included in the training data by using the training data.
(Supplementary note 3) In the security information analysis device according to supplementary note 1 or 2, the control means deletes the combination from the route when the combination of the search means capable of being simplified so as to delete information collection processing by search means is included in the route.
(Supplementary note 4) In the security information analysis device according to any one of supplementary notes 1 to 3, when a second combination which is a combination of search means replaceable with a first combination which is a combination for reducing the number of search means that perform information collection processing is included in the route, the control means replaces the second combination with the first combination.
(Supplementary note 5) In the security information analysis device according to any one of supplementary notes 1 to 4, the control means sorts portions of the combination in lexical order when a combination defined as interchangeable search means is included in the route.
(Supplementary note 6) In the security information analysis device according to any one of supplementary notes 1 to 5, the control means deletes one of combinations of overlapping search means included in the route.
(Supplementary note 7) In the security information analysis device according to any one of supplementary notes 1 to 6, the control means sorts portions of the combination in lexical order when a combination defined as interchangeable search means is included in the route, deletes the combination from the route when a combination of search means capable of being simplified so as to delete information collection processing by search means is included in the sorted route, replaces a second combination which is a combination of search means replaceable with a first combination which is a combination for reducing the number of search means that perform information collection processing, with the first combination, when the second combination is included in the route from which the combination is deleted, and deletes one of combinations of overlapping search means included in the replaced route.
(Supplementary note 8) There is provided a security information analysis system including the security analysis device according to any one of supplementary notes 1 to 7, evaluation means for repeating processing of selecting search means in accordance with a weight calculated by applying security information to an analysis model and processing of acquiring other security information by using the selected search means, and evaluation result providing means for generating a route based on the acquired security information.
(Supplementary note 9) There is provided a security information analysis method including repeating processing of acquiring new security information by inputting security information indicating information regarding a security event to search means for receiving input information and searching for the security information from an information provider that provides the security information and searching for another new security information by inputting the acquired security information to the search means. The search for the security information is changed to a search corresponding to a method indicated by simplification information defining a method for simplifying a combination of search means in which security information to be obtained does not increase when a route of the search means used for a series of searches for the security information includes the combination defined by the simplification information.
(Supplementary note 10) The security information analysis method according to v 9 further includes creating an analysis model for calculating a weight related to one or more search means in accordance with security information received as an input. In the creating of the analysis model, the analysis model is learned such that the weight of the search means capable of acquiring another security information included in one piece of training data including a plurality of pieces of the acquired security information from the information provider increases in accordance with the security information included in the training data by using the training data.
(Supplementary note 11) There is provided a security information analysis program causing a computer to execute control processing of repeating processing of acquiring new security information by inputting security information indicating information regarding a security event to search means for receiving input information and searching for the security information from an information provider that provides the security information and searching for another new security information by inputting the acquired security information to the search means. In the control processing, the search for the security information is changed to a search corresponding to a method indicated by simplification information defining a method for simplifying a combination of search means in which security information to be obtained does not increase when a route of the search means used for a series of searches for the security information includes the combination defined by the simplification information.
(Supplementary note 12) In the security information analysis program according to supplementary note 11, the security information analysis program causes the computer to further execute learning processing of creating an analysis model for calculating a weight related to one or more search means in accordance with security information received as an input. In the learning processing, the analysis model is learned such that the weight of the search means capable of acquiring another security information included in one piece of training data including a plurality of pieces of the acquired security information from the information provider increases in accordance with the security information included in the training data by using the training data.

### REFERENCE SIGNS LIST

100 Security information analysis device
101 Information collection unit
102 Learning unit
103 Analysis model storage unit
104 Training data supply unit
105 Information source
106 Simplification information storage unit
151 Analysis model learning unit
152 Route normalization unit
153 Route deletion unit
154 Route replacement unit
155 Overlapping route deletion unit
161 Table A storage unit
162 Table B storage unit
163 Table C storage unit
200 Security information evaluation device
201 Evaluation unit
202 Security information supply unit
203 Evaluation result providing unit
300, 400 Security information analysis system

What is claimed is:

1. A security information analysis device, comprising a hardware processor configured to execute a software code to
repeat processing of acquiring new security information by inputting security information indicating information regarding a security event to search means for receiving input information and searching for the security information from an information provider that provides the security information and searching for another new security information by inputting the acquired security information to the search means, and
simplification information storage means for storing simplification information defining a method for simplifying a combination of search means in which security information to be obtained does not increase,
wherein the hardware processor is configured to execute a software code to change the search for the security information to a search corresponding to the method indicated by the simplification information when a route of the search means used for a series of searches for the security information includes the combination defined by the simplification information.

2. The security information analysis device according to claim 1, wherein the hardware processor is configured to execute a software code to:
create an analysis model for calculating a weight related to one or more search means in accordance with security information received as an input; and
learn the analysis model such that the weight of the search means capable of acquiring another security information included in one piece of training data including a plurality of pieces of the acquired security information from the information provider increases in accordance with the security information included in the training data by using the training data.

3. The security information analysis device according to claim 1, wherein the hardware processor is configured to execute a software code to
delete the combination from the route when the combination of the search means capable of being simplified so as to delete information collection processing by search means is included in the route.

4. The security information analysis device according to claim 1,
wherein, when a second combination which is a combination of search means replaceable with a first combination which is a combination for reducing the number of search means that perform information collection processing is included in the route, the hardware processor is configured to execute a software code to replace the second combination with the first combination.

5. The security information analysis device according to claim 1,
wherein the hardware processor is configured to execute a software code to sort portions of the combination in lexical order when a combination defined as interchangeable search means is included in the route.

6. The security information analysis device according to claim 1,
wherein the hardware processor is configured to execute a software code to delete one of combinations of overlapping search means included in the route.

7. The security information analysis device according to claim 1,
wherein the hardware processor is configured to execute a software code to sort portions of the combination in lexical order when a combination defined as interchangeable search means is included in the route, delete the combination from the route when a combination of search means capable of being simplified so as to delete information collection processing by search means is included in the sorted route, replace a second combination which is a combination of search means replaceable with a first combination which is a combination for reducing the number of search means that perform information collection processing, with the first combination, when the second combination is included in the route from which the combination is deleted, and delete one of combinations of overlapping search means included in the replaced route.

8. A security information analysis system comprising:
the security information analysis device according to claim 1;
evaluation means for repeating processing of selecting search means in accordance with a weight calculated by applying security information to an analysis model and processing of acquiring other security information by using the selected search means; and
evaluation result providing means for generating a route based on the acquired security information.

9. A security information analysis method comprising:
repeating processing of acquiring new security information by inputting security information indicating information regarding a security event to search means for receiving input information and searching for the security information from an information provider that provides the security information and searching for another new security information by inputting the acquired security information to the search means,
wherein the search for the security information is changed to a search corresponding to a method indicated by simplification information defining a method for simplifying a combination of search means in which security information to be obtained does not increase when a route of the search means used for a series of searches for the security information includes the combination defined by the simplification information.

10. The security information analysis method according to claim 9, further comprising:
creating an analysis model for calculating a weight related to one or more search means in accordance with security information received as an input,
wherein, in the creating of the analysis model, the analysis model is learned such that the weight of the search means capable of acquiring another security information included in one piece of training data including a plurality of pieces of the acquired security information from the information provider increases in accordance with the security information included in the training data by using the training data.

11. A non-transitory computer readable information recording medium storing a security information analysis program, when executed by a processor, that performs a method for:
repeating processing of acquiring new security information by inputting security information indicating information regarding a security event to search means for receiving input information and searching for the security information from an information provider that provides the security information and searching for another new security information by inputting the acquired security information to the search means,
wherein the search for the security information is changed to a search corresponding to a method indicated by simplification information defining a method for simplifying a combination of search means in which security information to be obtained does not increase when a route of the search means used for a series of searches for the security information includes the combination defined by the simplification information.

12. The non-transitory computer readable information recording medium according to claim 11, further comprising:
creating an analysis model for calculating a weight related to one or more search means in accordance with security information received as an input,
wherein, in the creating of the analysis model, the analysis model is learned such that the weight of the search means capable of acquiring another security information included in one piece of training data including a plurality of pieces of the acquired security information from the information provider increases in accordance with the security information included in the training data by using the training data.
